(19) United States
(12) Patent Application Publication
(10) Pub. No.: US 2020/0019435 A1
(43) Pub. Date: Jan. 16, 2020

(54) DYNAMIC OPTIMIZING TASK SCHEDULING

(71) Applicant: Raytheon Company, Waltham, MA (US)

(72) Inventors: Jeffrey T. Stevenson, Greenwood Village, CO (US); Marcus Alton Teter, Belgrade, MT (US)

(21) Appl. No.: 16/510,370

(22) Filed: Jul. 12, 2019

Related U.S. Application Data
(60) Provisional application No. 62/697,832, filed on Jul. 13, 2018.

(51) Int. Cl. G06F 9/48; G06F 9/50; G06N 5/02; G06F 9/54; H04B 7/185

(52) U.S. Cl. CPC G06F 9/4881; G06F 9/5038; H04B 7/185; G06F 9/544; G06N 5/025

(57) ABSTRACT

Near-optimal schedules are generated for shared resources. Multiple instances of a schedule are generated for operation of the shared resources. Each instance of the schedule is processed to produce a corresponding locally-optimized schedule instance. Evaluation criteria and selection logic are applied to each locally-optimized schedule instance to select a best schedule to meet a current circumstance represented by a global rule set. An updated global rule set, which represents a change to the current circumstance, is received, and the evaluation criteria and the selection logic are adjusted in response to the updated global rule set to produce updated evaluation criteria and updated selection logic. The updated evaluation criteria and the updated selection logic are applied to each locally-optimized schedule instance to select the best schedule to meet the current circumstance represented by the updated global rule set.

### RELATED APPLICATIONS

The present application claims priority to U.S. Provisional Application Ser. No. 62/697,832, filed on Jul. 13, 2018, which is incorporated herein by reference in its entirety.

### TECHNICAL FIELD

Embodiments described herein generally relate to data processing and tactical task scheduling, and more particularly, to self-optimization of task scheduling to support dynamically-varying circumstances.

### BACKGROUND

Shared resources that are utilized by different entities, such as satellites and constellations of satellites for example, are operated according to a scheduling scheme to facilitate the sharing by the entities. These entities may include government, military, civilian, or non-government entities. Tasks may include exclusive communications with a satellite by an entity, or a sequence of actions to be performed by a satellite on behalf of an entity, for example. Typically, a scheduling system works to prioritize tasks and optimize allocation of the shared resource to meet the needs of each entity as much as possible.

Conventional schedulers, and in particular satellite constellation schedulers, typically assume a daily schedule that is generally static in nature. They tend not to dynamically optimize the insertion of ad-hoc tasks into the schedule or optimize the schedule repair process in near real-time. As such, conventional schedulers have difficulty in handling stressing situations where critical demand may exceed the available time of the shared resource. Also, conventional solutions are not well suited to support ad-hoc tasking and “bumping” of contact pairings automatically and dynamically. Changing (“bumping”) ground communication antenna to satellite pairings to support ad-hoc tasking can create complex schedule repair problems that are difficult to resolve in an optimized, near-real-time (NRT) manner. Conventional schedulers are not designed, as a fundamental orientation, toward putting priorities on missions and on urgent ad-hoc task requests under stressing and dynamic contingency operations scenarios.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a high-level diagram illustrating a system architecture of a dynamic scheduling system according to some embodiments.

FIG. 2 is a block diagram illustrating a computing platform in the example form of a general-purpose machine.

FIG. 3 is a diagram illustrating an exemplary hardware and software architecture of a computing device such as the one depicted in FIG. 2, in which various interfaces between hardware components and software components are shown.

FIG. 4 is a block diagram illustrating examples of processing devices that may be implemented on a computing platform, such as the computing platform described with reference to FIGS. 2-3, according to an embodiment.

FIG. 5 is a diagram illustrating a method of optimizing scheduling according to some embodiments.

FIGS. 6A, 6B, and 6C are another diagram illustrating a method of optimizing scheduling according to some embodiments.

FIG. 7 is a diagram illustrating an auto-scheduler according to a related embodiment.

### DETAILED DESCRIPTION

Aspects of the embodiments are directed to systems and methods for scheduling of dynamic, ad-hoc, high operational-tempo tasking in near real-time (NRT). Some embodiments utilize urgency-based prioritized scheduling as the basis for an objective/cost function. Related embodiments work to maximize the number of on-time task requests, e.g., broadcast start times, and minimize the number of late or rejected task requests. Related embodiments are directed to an optimizing scheduler that automatically performs schedule repair in near real-time in response to receiving ad-hoc tasking that perturbs the contact schedule. Another embodiment provides a model of an algorithm which dynamically inserts ad-hoc tasks (or contacts) into a constellation schedule in near real-time using an optimization approach based on a heuristics and priority model using a particle swarm optimization algorithm.

Particle swarm optimization algorithms have not been used for near real-time dynamic tasking and optimization of satellite constellation schedules as part of an advanced mission planning and scheduling system for global navigation systems. Consequently, an embodiment involves a particle swarm optimization model application to dynamic operational satellite mission planning and scheduling systems for advanced global positioning ad-hoc task insertion in near real-time. The model performs constellation schedule repair on-the-fly in near real-time using a particle swarm optimization algorithm to select the global best schedule after iterating through particle schedules to find the near optimal solution.

An advanced automated particle swarm optimization scheduler allows dynamic ad-hoc task scheduling of satellite tasks and also repairs the operational schedule in an optimized manner given limited system resources and scheduling time with respect to a near real-time tasking model for all or some of the constellation. The scheduling model allows highly dynamic scheduling of uploads and tasks to the satellites given a limited number of antennas for contacting the satellites. The model allows existing scheduled tasks and contacts to be bumped, changed, and re-scheduled given a set of priority-based heuristic rules. The schedule repair model outputs the results in an optimized constellation contact schedule by iterating over candidate schedules using the particle swarm optimization algorithm to converge on the near-optimal schedule in near real-time. The model inputs include dynamic tasking constraints and tasking priorities to be used as a heuristic basis for determining the “goodness” of the candidate schedules with the local best particle schedules being identified as a basis for determining the global best schedule in terms of the entire particle schedule swarm for the satellite constellation. The particle schedules are candidate schedules that are generated considering different circumstances, priorities, urgencies, and tasking patterns. The particle generator embodies machine learning methods to learn scheduling patterns over time based on tasking patterns. Tasking patterns are derived by analyzing low-level tasking requests on-the-fly.

The innovative aspects of the advanced optimizing automated satellite constellation scheduler include the novel use of a particle swarm optimization schedule to algorithmically and automatically generate an updated optimized satellite constellation schedule in near real-time given limited resources, priority-constraints, and tasking timing constraints. It also optimizes the ad-hoc tasking inputs for a subset of the satellites being scheduled to perform tasks in terms of uploaded, updated navigation data, broadcast schedules, payload schedules, and satellite bus schedules while ensuring the priorities of all conflicting resource contention issues are resolved by a global best schedule for an adaptable schedule window into the future.

Embodiments perform near-optimal schedule repair in near real-time (NRT) after new tasks, and potentially new contacts, are inserted into a schedule. Systems and methods according to aspects of the embodiments can identify and prioritize alternative schedules based on urgent mission tasking.

Some embodiments utilize particle-swarm optimization algorithms for NRT dynamic tasking and optimization of satellite constellation schedules as part of an advanced mission planning and scheduling system for global navigation systems or other shared resources. Embodiments may perform constellation schedule repair on-the-fly in near real-time using a particle swarm optimization algorithm to select the global best schedule after iterating through particle schedules to find the near optimal solution.

Examples are described in the context of global position system satellite constellation mission planning and scheduling systems, though it will be understood that a variety of other scheduling-intensive applications may benefit from implementation of aspects of the embodiments.

According to various embodiments, multiple instances of schedules for a given shared resource are generated, and individually processed by a scheduling-optimization algorithm. Each optimized schedule instance may be a viable solution in its own right, but certain optimized schedules may better meet the needs according to a current set of circumstances than other optimized schedules. In other words, the various instances of optimized schedules may be optimized for different circumstances. Aspects of the embodiments recognize that the current circumstances may vary over time. Thus, a set of evaluation criteria and a set of selection logic are applied to the multiple instances of optimized schedules to select a best schedule to meet the current circumstances. The evaluation criteria and selection logic are dynamic and may be updated in near real-time based on the patterns determined using machine learning. Scheduling logic, schedule selection logic, and schedule evaluation rules may be updated over time by the auto-scheduler embodiments.

In a related embodiment, the optimization of each schedule instance is iteratively performed in response to changes, such as the addition of a task, or a revision of an optimization rule, for instance. Likewise, the evaluation criteria may be varied, or the current circumstances may change, leading to an updated selection of the best optimized schedule to meet the dynamically-evolving needs of the system operator.

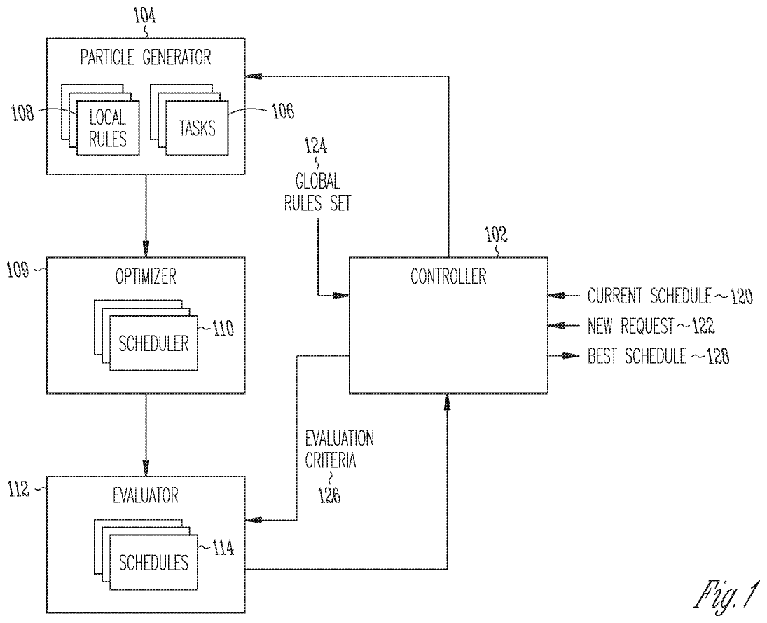

FIG. 1 is a high-level diagram illustrating a system architecture of a dynamic scheduling system according to some embodiments. FIG. 1 depicts a dynamic optimizing task scheduler circuit, which schedules multiple task request inputs for a satellite constellation using particle swarm optimization. The current schedule 120, the global rule set 124, and new task requests 122 are inputs to the controller 102. The controller 102 groups tasks based on urgency and priority and passes the logical groupings to the particle generator 104. The particle generator 104 generates candidate schedules by inserting tasks 106 on the schedule and removing other tasks based on the local rule set 108 for each particle (i.e., schedule). Candidate schedules are outputs of the particle generator 104. The schedule optimizer 109 updates dynamic priorities to further optimize the local particle schedules, and updates local rule sets 108 based on tasking patterns learned using machine learning techniques. Various dynamic mission patterns and urgency states are used by the optimizer 109 to update the local best schedules. The evaluator 112 then determines the global best schedule 128 based on the cost of implementing the task requests 122 and current global circumstances and the global rule set 124. Using the current evaluation criteria 126, the global best is returned to the controller which optimally uses a limited set of resources.

More specifically, FIG. 1. illustrates a controller 102 that is an engine constructed, programmed, or otherwise configured to accept as its input the current schedule 120 and a new request 122 calling for a schedule change. New request 122 may be the addition of a task for a particular customer, for example. Controller 102 also receives as an input global rule set 124 representing the current needs of the system operator. Global rule set 124 reflects the current circumstances that inform the selection of one of the optimized instances of the schedule.

Controller 102 is configured to generate evaluation criteria 126 for use by evaluator engine 112 to score each instance of the optimized schedule according to multi-dimensional scoring criteria. An example of the scoring criteria include ensuring that each satellite receives updated navigation data to maintain navigation solution accuracy while still meeting needs of other payloads, the satellite bus, and mission operational needs. As an output, controller 102 produces a selection of the best schedule 128 to be deployed in the current schedule-selection iteration, based on the scoring by the evaluator 112. Controller 102 may initiate a new schedule-selection iteration in response to new request 122.

In each schedule-selection iteration, controller 102 calls particle generator 104 to produce a set of schedules. In some embodiments, the call to particle generator 104 includes the current schedule 120 and new request 122. In a related example, the call may also include global rule set 124.

Particle generator 104 is an engine that is constructed, programmed, or otherwise configured, to generate multiple instances of the schedule. Each instance includes a set of tasks 106 to be performed, and also includes local rules 108 that govern the requirements for each task and inform the optimization of the schedule. For instance, a given task may be associated with a local rule that identifies a certain deadline by which the task is to be completed, or a time window in which the task is to be carried out. The task may also be associated with another local rule that calls for the task to be carried out using a certain set of sub-resources of the shared resource, such as a particular communications module of a satellite.

Particle generator 104 may vary the local rules for each instance of the schedule that is produced. Variation of the local rules 108 may be based on a deterministic function or the variation may be stochastic in nature. The variation of the local rules may also be based on the global rule set 124, for example.

Each instance of the schedule (also referred to as a particle in the context of a particle swarm optimization algorithm) is passed to optimizer 109. Optimizer 109 is an engine that is constructed, programmed, or otherwise configured, to iteratively optimize each individual schedule instance based on that schedule's local rules. Each particle schedule generator uses a different mission perspective and parameter set to develop each local particle schedule. Adjustment of a schedule instance may include ordering (or re-ordering) the tasks of that schedule. Each schedule instance may have multiple configurations that meet the local rules. Accordingly, optimizer 109 may operate iteratively to have a schedule instance converge to an optimal configuration based on the optimization algorithm of optimizer 109. Each schedule instance that meets its local rules is output as an optimized scheduler instance 110, and passed to evaluator 112.

Evaluator 112 is an engine that is constructed, programmed, or otherwise configured, to assign scoring to each optimized schedule instance 110. Numbers of late and rejected task requests are scoring metrics. Scoring may be in the form of a multi-dimensional vector of values, with each value corresponding to a scoring parameter. The scoring parameters, weightings, and parameter-specific scoring criteria are based on evaluation criteria 126 provided by controller 102. Evaluator 112 associates each scoring set to its corresponding optimized scheduler instance 110 to produce scored schedules 114. The set of multiple scored schedules 114 is passed to controller 102 for preferential selection of the best schedule 128. For example, the best schedule 128 may be the schedule that is arranged such that all task and new tasks for all customers are completed in the least amount of time.

Notably, global rule set 124 may vary dynamically based on changing circumstances. Accordingly, the selection of the best schedule by controller 102 may be varied independently of any changes to schedule instance optimization that were applied by optimizer 109 to form each optimized schedule instance 110. Global rule set 124 may vary independently of any new request 122. Variation of global rule set 124 may drive the definitions of evaluation criteria 126, the selection logic used by controller 102 to select the best schedule, or both sets of criteria.

In one sense, optimizer 108 operates as a first optimization loop to select the local-best schedule, and operation of evaluator 112 and the selection of the best schedule by controller 102 operates as a second optimization loop to select the global-best schedule.

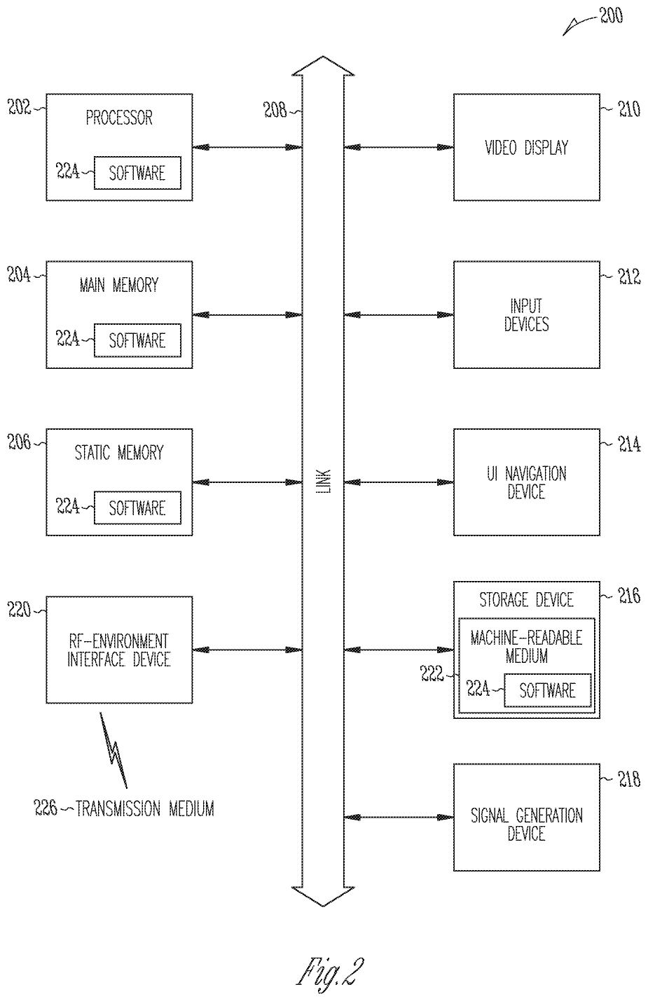

FIG. 2 is a block diagram illustrating a computing and communications platform 200 in the example form of a general-purpose machine on which some or all of the system of FIG. 1 may be carried out according to various embodiments. In certain embodiments, programming of the computing platform 200 according to one or more particular algorithms produces a special-purpose machine upon execution of that programming. In a networked deployment, the computing platform 200 may operate in the capacity of either a server or a client machine in server-client network environments, or it may act as a peer machine in peer-to-peer (or distributed) network environments. Computing platform 200, or some portions thereof, may represent an example architecture of computing platform 106 or external computing platform 104 according to one type of embodiment.

Example computing platform 200 includes at least one processor 202 (e.g., a central processing unit (CPU), a graphics processing unit (GPU) or both, processor cores, compute nodes, etc.), a main memory 204 and a static memory 206, which communicate with each other via a link 208 (e.g., bus). The computing platform 200 may further include a video display unit 210, input devices 212 (e.g., a keyboard, camera, microphone), and a user interface (UI) navigation device 214 (e.g., mouse, touchscreen). The computing platform 200 may additionally include a storage device 216 (e.g., a drive unit), a signal generation device 218 (e.g., a speaker), and a RF-environment interface device (RFEID) 220.

The storage device 216 includes a non-transitory machine-readable medium 222 on which is stored one or more sets of data structures and instructions 224 (e.g., software) embodying or utilized by any one or more of the methodologies or functions described herein. The instructions 224 may also reside, completely or at least partially, within the main memory 204, static memory 206, and/or within the processor 202 during execution thereof by the computing platform 200, with the main memory 204, static memory 206, and the processor 202 also constituting machine-readable media.

While the machine-readable medium 222 is illustrated in an example embodiment to be a single medium, the term “machine-readable medium” may include a single medium or multiple media (e.g., a centralized or distributed database, and/or associated caches and servers) that store the one or more instructions 224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

RFEID 220 includes radio receiver circuitry, along with analog-to-digital conversion circuitry, and interface circuitry to communicate via link 208 according to various embodiments. Various form factors are contemplated for RFEID 220. For instance, RFEID may be in the form of a wideband radio receiver, or scanning radio receiver, that interfaces with processor 202 via link 208. In one example, link 208 includes a PCI Express (PCIe) bus, including a slot into which the NIC form-factor may removably engage. In another embodiment, RFEID 220 includes circuitry laid out on a motherboard together with local link circuitry, processor interface circuitry, other input/output circuitry, memory circuitry, storage device and peripheral controller circuitry, and the like. In another embodiment, RFEID 220 is a peripheral that interfaces with link 208 via a peripheral input/output port such as a universal serial bus (USB) port. RFEID 220 receives RF emissions over wireless transmission medium 226. RFEID 220 may be constructed to receive RADAR signaling, radio communications signaling, unintentional emissions, or some combination of such emissions.

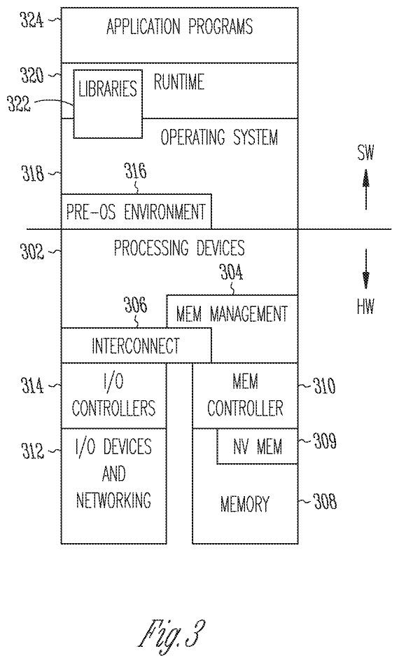

FIG. 3 is a diagram illustrating an exemplary hardware and software architecture of a computing device such as the one depicted in FIG. 2, in which various interfaces between hardware components and software components are shown. As indicated by HW, hardware components are represented below the divider line, whereas software components denoted by SW reside above the divider line. On the hardware side, processing devices 302 (which may include one or more microprocessors, digital signal processors, etc.), each having one or more processor cores, are interfaced with memory management device 304 and system interconnect 306. Memory management device 304 provides mappings between virtual memory used by processes being executed, and the physical memory. Memory management device 304 may be an integral part of a central processing unit which also includes the processing devices 302.

Interconnect 306 includes a backplane such as memory, data, and control lines, as well as the interface with input/output devices, e.g., PCI, USB, etc. Memory 308 (e.g., dynamic random access memory or DRAM) and non-volatile memory 309 such as flash memory (e.g., electrically-erasable read-only memory such as EEPROM, NAND Flash, NOR Flash, etc.) are interfaced with memory management device 304 and interconnect 306 via memory controller 310. This architecture may support direct memory access (DMA) by peripherals in one type of embodiment. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 312, which interface with interconnect 306 via corresponding I/O controllers 314.

On the software side, a pre-operating system (pre-OS) environment 316 is executed at initial system start-up and is responsible for initiating the boot-up of the operating system. One traditional example of pre-OS environment 316 is a system basic input/output system (BIOS). In present-day systems, a unified extensible firmware interface (UEFI) is implemented. Pre-OS environment 316, is responsible for initiating the launching of the operating system, but also provides an execution environment for embedded applications according to certain aspects of the invention.

Operating system (OS) 318 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 318 provides device drivers, and a variety of common services such as those that facilitate interfacing with peripherals and networking, that provide abstraction for application programs so that the applications do not need to be responsible for handling the details of such common operations. Operating system 318 additionally provides a graphical user interface (GUI) engine that facilitates interaction with the user via peripheral devices such as a monitor, keyboard, mouse, microphone, video camera, touchscreen, and the like.

Runtime system 320 implements portions of an execution model, including such operations as putting parameters onto the stack before a function call, the behavior of disk input/output (I/O), and parallel execution-related behaviors. Runtime system 320 may also perform support services such as type checking, debugging, or code generation and optimization.

Libraries 322 include collections of program functions that provide further abstraction for application programs. These include shared libraries and dynamic linked libraries (DLLs), for example. Libraries 322 may be integral to the operating system 318, runtime system 320, or may be added-on features, or even remotely- hosted. Libraries 322 define an application program interface (API) through which a variety of function calls may be made by application programs 324 to invoke the services provided by the operating system 318. Application programs 324 are those programs that perform useful tasks for users, beyond the tasks performed by lower-level system programs that coordinate the basis operability of the computing device itself.

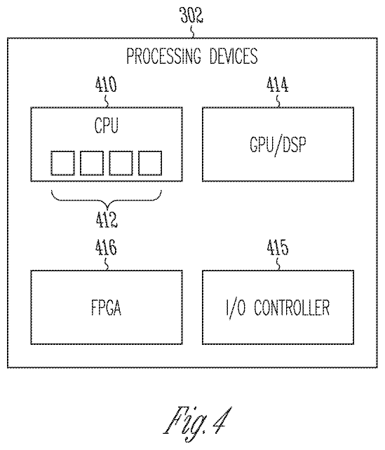

FIG. 4 is a block diagram illustrating processing devices 302 according to one type of embodiment. CPU 410 may contain one or more processing cores 412, each of which has one or more arithmetic logic units (ALU), instruction fetch unit, instruction decode unit, control unit, registers, data stack pointer, program counter, and other essential components according to the particular architecture of the processor. As an illustrative example, CPU 410 may be a x86-type of processor. Processing devices 302 may also include a graphics processing unit (GPU) or digital signal processor (DSP) 414. In these embodiments, GPU/DSP 414 may be a specialized co-processor that offloads certain computationally-intensive operations, particularly those associated with numerical computation, from CPU 410. Notably, CPU 410 and GPU/DSP 414 may work collaboratively, sharing access to memory resources, I/O channels, etc.

Processing devices 302 may also include a specialized processor 416, such a field-programmable gate array (FPGA), for example. Specialized processor 416 generally does not participate in the processing work to carry out software code as CPU 410 and GPU 414 may do. In one type of embodiment, specialized processor 416 is configured to execute time-critical operations, such as real-time, or near-real-time signal processing. Specialized processor 416 may execute dedicated firmware. Specialized processor 416 may also include a dedicated set of I/O facilities to enable it to communicate with external entities. Input/output (I/O) controller 415 coordinates information flow between the various processing devices 410, 414, 416, as well as with external circuitry, such as a system interconnect.

Examples, as described herein, may include, or may operate on, logic or a number of components, circuits, or engines, which for the sake of consistency are termed engines, although it will be understood that these terms may be used interchangeably. Engines may be hardware, software, or firmware communicatively coupled to one or more processors in order to carry out the operations described herein. Engines may be hardware engines, and as such engines may be considered tangible entities capable of performing specified operations and may be configured or arranged in a certain manner. In an example, circuits may be arranged (e.g., internally or with respect to external entities such as other circuits) in a specified manner as an engine. In an example, the whole or part of one or more computing platforms (e.g., a standalone, client or server computing platform) or one or more hardware processors may be configured by firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein.

Considering examples in which engines are temporarily configured, each of the engines need not be instantiated at any one moment in time. For example, where the engines comprise a general-purpose hardware processor configured using software, the general-purpose hardware processor may be configured as respective different engines at different times. Software may accordingly configure a hardware processor, for example, to constitute a particular engine at one instance of time and to constitute a different engine at a different instance of time.

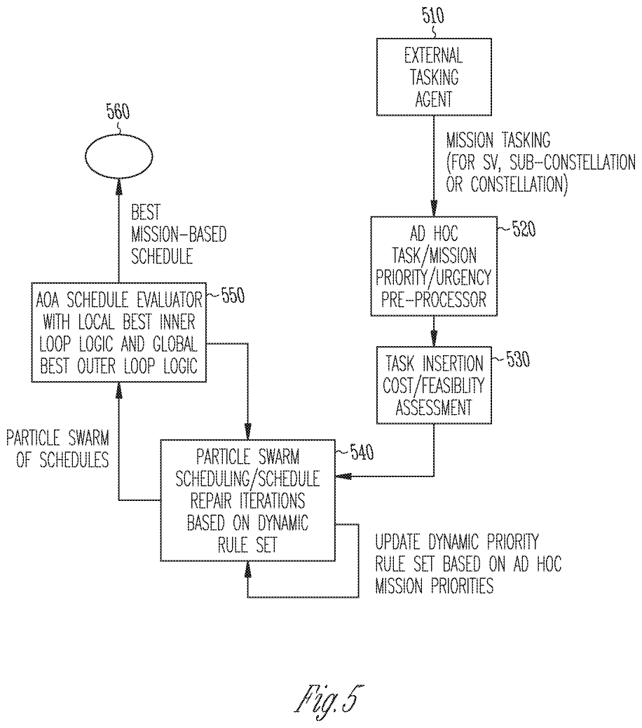

FIG. 5 is an example diagram illustrating a method of optimizing scheduling according to some embodiments. An external tasking agent 510 supplies mission tasking information to an ad-hoc pre-processing operation 520. The ad-hoc pre-processing 520 prioritizes tasks or missions according to priority or urgency, for example. A task insertion cost or feasibility assessment 530 follows, which may be iterated and re-run based on newly-inserted tasks as an inner optimization loop. Next, particle-swarm scheduling/schedule repair operations 540 are performed based on a dynamic rule set (e.g., local rules). Next, each schedule is evaluated at 550 with global-selection criteria as an outer optimization loop. A best scheduled is then arrived at 560.

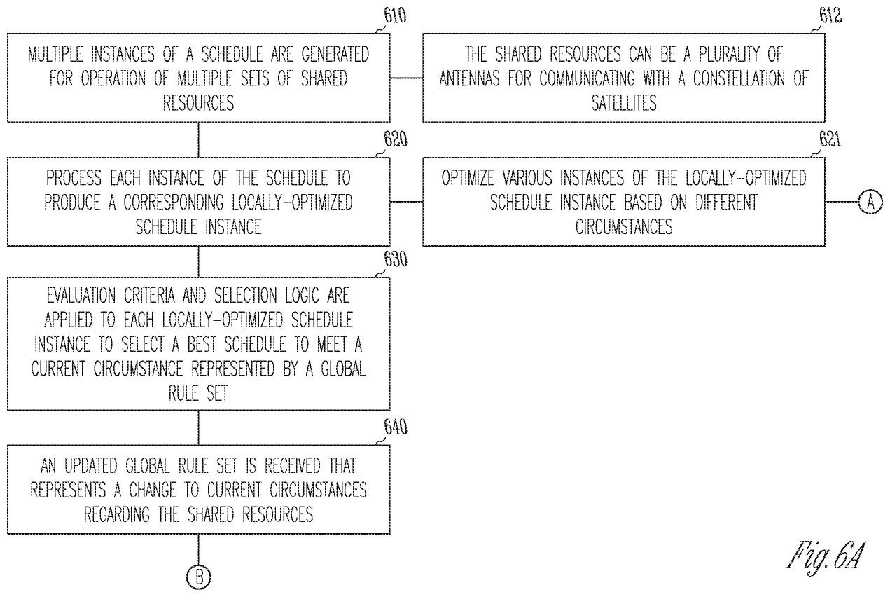

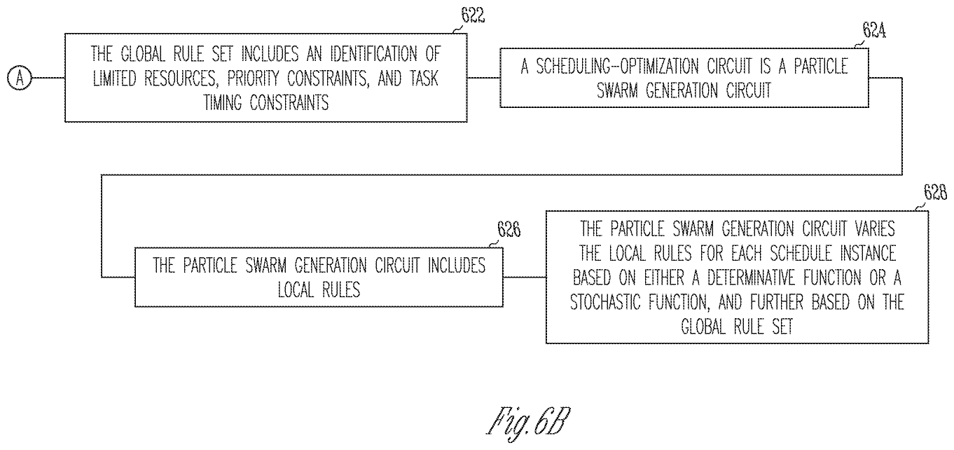

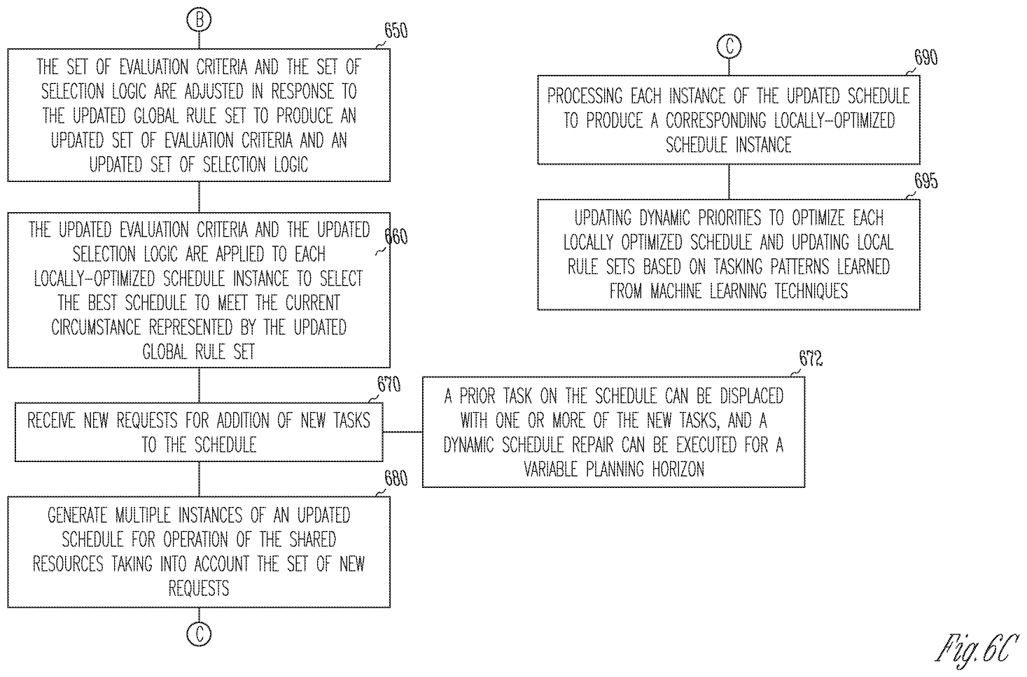

FIGS. 6A, 6B, and 6C are another example diagram illustrating a method of optimizing scheduling according to some embodiments. In FIG. 6A, at 610, multiple instances of a schedule are generated for operation of multiple sets of shared resources. As indicated at 612, in an embodiment, the shared resources can be a plurality of antennas for communicating with a constellation of satellites. The multiple instances of the schedule can include different instances of use of the antennas, use of the different satellites, use of different modules on the satellites, and use of tasks and priorities of tasks on the satellites, just to list a few examples.

At 620, a scheduling-optimization circuit individually processes each instance of the schedule to produce a corresponding locally-optimized schedule instance, and at 630, a set of evaluation criteria and a set of selection logic are applied to each locally-optimized schedule instance to select a best schedule to meet a current circumstance represented by a global rule set. The scheduling-optimization circuit optimizes various instances of the locally-optimized schedule instance based on different circumstances (621). In FIG. 6B, as indicated at 622, the global rule set can include an identification of limited resources, priority constraints, and task timing constraints. In an embodiment, the scheduling-optimization circuit is a particle swarm generation circuit (624). Such a particle swarm generation circuit can include local rules (626), and the particle swarm generation circuit as indicated at 628 varies the local rules for each schedule instance based on either a deterministic function or a stochastic function, and further based on the global rule set.

Referring back to FIG. 6A, at 640, an updated global rule set is received that represents a change to current circumstances regarding the shared resources. In FIG. 6C, at 650, the set of evaluation criteria and the set of selection logic are adjusted in response to the updated global rule set to produce an updated set of evaluation criteria and an updated set of selection logic. At 660, the updated set of evaluation criteria and the updated set of selection logic are applied to each locally-optimized schedule instance to select the best schedule to meet the current circumstance represented by the updated global rule set.

At 670, the process further includes receiving a set of new requests for addition of new tasks to the schedule. As indicated at 672, a prior task on the schedule can be displaced with one or more of the new tasks, and a dynamic schedule repair can be executed for a variable planning horizon. A variable planning horizon may be used to generate particle schedules for varying amounts of time in the future. This allows the particle schedule to converge on a particle schedule in near real-time and reduces the schedule generation and evaluation complexity. The particle scheduler runs when new tasking requests are received and may also run routinely to update the schedule based on resource availability and other circumstances. A full day's schedule may not be generated for each global best schedule that is generated. Once a global best schedule is selected, the particle schedule generator automatically begins working on the schedule for the next planning horizon in a pipeline manner. At 680, first multiple instances of an updated schedule for operation of the multiple sets of the shared resources are generated taking into account the set of new requests, and then at 690, the scheduling-optimization circuit individually processes each instance of the updated schedule to produce a corresponding locally-optimized schedule instance.

Finally, as indicated at 695, the process can update dynamic priorities to optimize each locally optimized schedule and can update local rule sets based on tasking patterns learned from machine learning techniques.

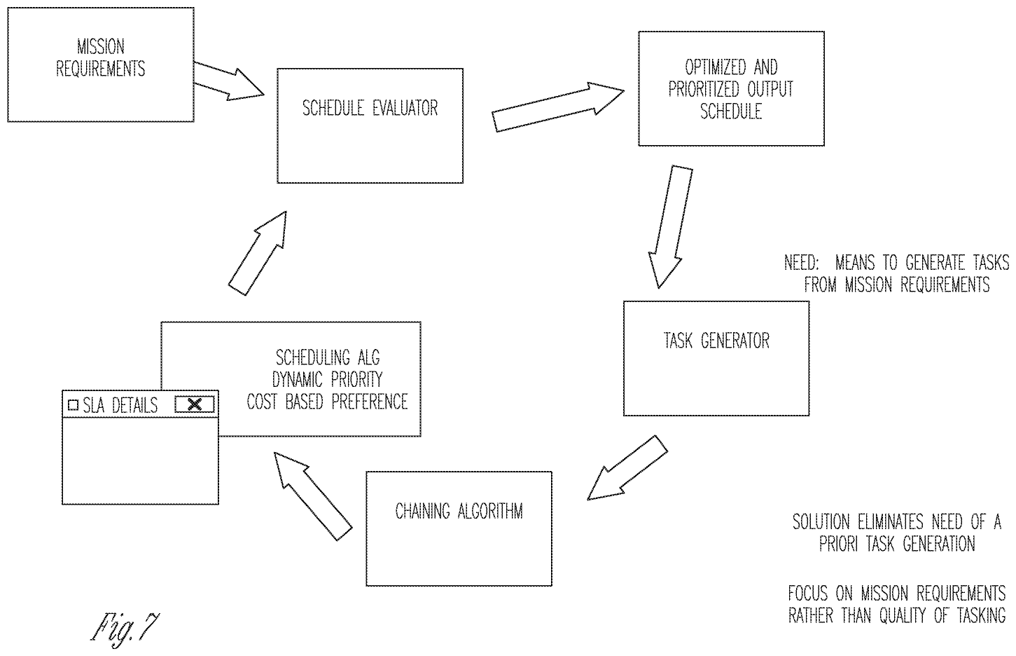

FIG. 7 is a diagram illustrating an auto-scheduler according to a related embodiment. This approach uses advanced optimization and artificial intelligence (AI) learning models to arrive at a near-optimal scheduling solution in near-real time. Based on optimization models such as metaheuristic approaches, e.g., Particle Swarm Optimization (PSO), this example system determines the limits of scheduling infrastructure with respect to ad-hoc tasking of a large evolutionary satellite constellations under stressing scenarios and supports scalability of the size of the satellite constellation.

In summary, an embodiment uses an artificially intelligent (AI)-based particle swarm algorithm to determine and select the best schedule among a plurality of schedules, and further uses the particle swarm algorithm to revise the selected best schedule when new tasks and/or other contingencies are introduced. Such new tasks can come in on regular or continuous basis, and unlike static prior art scheduling processes (which must be worked out in advance of deployment and are so labor intensive that only one schedule is normally constructed and rarely if ever modified), none of these tasks are rejected. Rather, the AI-based particle swarm algorithm determines a way to handle all tasks, both old and new. In short, AI is being used to, instead of just building one schedule, building multiple schedules at the same time and evaluating them.

In further contrast to the one-schedule, non-modifiable prior art processes, a multitude of schedules is launched with different tasking constraints, and through the AI processing, it is determined if a solution optimizes multiple parameters at the same time. This is particularly advantageous in a system of multiple satellites (with limited ground antennas), because of all the different missions that could be contradictory to one another. An embodiment therefore optimizes the schedules based on priority or urgency of the tasks. For example, the priority-based schedules are sorted by priority, and also no tasks are removed because of this priority-based system.

The particle swarm optimization treats the multiple schedules as particles. The optimizer concurrently executes multiple solutions to the scheduling issues, and then based on the current priorities and urgencies, the optimizer selects the best schedule. That is, local best schedules are concurrently built, and then the evaluator eventually selects the best global schedule based on the evaluation criteria (for the current situation) provided by the controller.

When a new task is introduced, there are multiple ways of implementing that new task, and each implementation will disrupt the current schedule in different ways. To handle this, the particle swarm circuit processes all of those multiple ways to handle the new task, and processes them all concurrently. That is, the particle swarm circuit fixes the schedule, as long as there are many instances so that an optimized solution can be arrived at.

There is an inner loop that determines the local best schedule based on one set of tasks among groups of tasks. The particle swarm circuit examines each group based on each group's different perspectives. The inner loop can be thought of as the optimizer, and the particle swarm circuit can be thought of as an outer loop. That is, the outer loop provides all the different schedules to the particle swarm circuit and the particle swarm circuit selects the best schedule. Because any of these schedules could be considered the best at any given moment, the system continuously tries to improve the schedules up until the moment that a particular task has to occur. Every schedule is executable after every completion of every loop. Once the inner loop is completed, the outer loop selects a schedule (schedule tester). The first test determines validity (e.g., all tasks are performed) and the second test is to determine what valid schedule is the best.

An embodiment prevents what can be referred to as starvation of critical tasks. That is, an urgent task may not always be the highest priority task. However, it is a task that must get done, and a particular mission for a satellite cannot be starved, that is, not done or not done in a timely manner.

The controller receives information, such as a current schedule and a new request. A global set of rules is resident in the system. The evaluator is provided with a set of criteria. The received information is transmitted to the particle generator, which set ups a set of local rules for each of the particles (schedules) and also sets up a set of individual tasks for the individual particles. The particle generator in essence builds the loops. The particle generator sends the loops to the optimizer (which in a sense is a scheduler by itself). The particle generator and optimizer go through the looping mechanism of auto-scheduling until they arrive at solutions, and these solutions are passed to the evaluator. The evaluator uses the evaluation criteria provided by the controller to determine how to rank the schedules in order from best to worst. The evaluator then passes the best schedule to the controller. The best schedule is either passed on for use in the (satellite) system, or a new request comes in and the particle generator, optimizer, and evaluator go through the process again. The system can therefore be operating continuously so that the system always provides the best schedule based on the latest new request. It is a rare instance when a new task is rejected.

There is a bumping concept. For example, if there is a full and packed schedule that is currently being executed, a new task that comes in may force the bumping of another task and a reworking of the schedule so that that new task can be inserted. The global rule set is used and the new request guides the establishment of the evaluation criteria. In prior systems, if a new request could not be fitted or incorporated into a system, it would be rejected. However, in an embodiment, the new request is handled as a new requirement and processed.

An example of a rule in the global rule set is that a particular antenna in a satellite system can only be used a certain number of hours before it needs to be taken offline for maintenance. So the global rule set includes rules that are known to have to be done at the time that the system is established. That is, the optimal number of hours that an antenna can be used before it must be taken offline for a while. In system operation, the amount of slack that can be tolerated may be an input to the auto-scheduler embodiment. The system may dynamically change this to meet such maintenance goals.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A machine-implemented method for generating a near-optimal schedule for a set of shared resources, the method comprising:
generating multiple instances of a schedule for operation of multiple sets of the shared resources;
individually processing, by a scheduling-optimization circuit, each instance of the schedule to produce a corresponding locally-optimized schedule instance;
applying a set of evaluation criteria and a set of selection logic to each locally-optimized schedule instance to select a best schedule to meet a current circumstance represented by a global rule set;
receiving an updated global rule set representing a change to the current circumstance;
adjusting the set of evaluation criteria and the set of selection logic in response to the updated global rule set to produce an updated set of evaluation criteria and an updated set of selection logic;
updating dynamic priorities to optimize each locally optimized schedule instance and updating local rule sets based on tasking patterns learned from machine learning techniques; and
applying the updated set of evaluation criteria and the updated set of selection logic to each locally-optimized schedule instance to select the best schedule to meet the current circumstance represented by the updated global rule set.

2. The method of claim 1, comprising:
receiving a set of new requests for addition of new tasks to the schedule; and
in response to the set of new requests:
generating multiple instances of an updated schedule for operation of the multiple sets of the shared resources taking into account the set of new requests; and
individually processing, by the scheduling-optimization circuit, each instance of the updated schedule to produce a corresponding locally-optimized schedule instance.

3. The method of claim 2, comprising displacing a prior task on the schedule with one or more of the new tasks and performing a dynamic schedule repair for a variable planning horizon.

4. The method of claim 1, wherein the shared resource comprises one or more antennas for communicating with one or more satellites.

5. The method of claim 1, wherein the scheduling optimization circuit comprises a particle swarm generation circuit.

6. The method of claim 5, wherein the particle swarm generation circuit comprises local rules, and wherein the particle swarm generation circuit varies the local rules for each schedule instance based on either a deterministic function or a stochastic function, and further based on the global rule set.

7. The method of claim 1, wherein the global rule set comprises an identification of limited resources, priority constraints, and task timing constraints.

8. The method of claim 1, wherein the processing by the scheduling-optimization circuit optimizes various instances of the locally-optimized schedule instance based on different circumstances.

9. A non-transitory computer-readable medium comprising instructions that when executed by a processor execute a process for generating a near-optimal schedule for a set of shared resources comprising:
generating multiple instances of a schedule for operation of multiple sets of the shared resources;
individually processing, by a scheduling-optimization circuit, each instance of the schedule to produce a corresponding locally-optimized schedule instance;
applying a set of evaluation criteria and a set of selection logic to each locally-optimized schedule instance to select a best schedule to meet a current circumstance represented by a global rule set;
receiving an updated global rule set representing a change to the current circumstance;
adjusting the set of evaluation criteria and the set of selection logic in response to the updated global rule set to produce an updated set of evaluation criteria and an updated set of selection logic;
updating dynamic priorities to optimize each locally optimized schedule instance and updating local rule sets based on tasking patterns learned from machine learning techniques; and
applying the updated set of evaluation criteria and the updated set of selection logic to each locally-optimized schedule instance to select the best schedule to meet the current circumstance represented by the updated global rule set.

10. The non-transitory computer-readable medium of claim 9, comprising instructions for:
receiving a set of new requests for addition of new tasks to the schedule; and
in response to the set of new requests:
generating multiple instances of an updated schedule for operation of the multiple sets of the shared resources taking into account the set of new requests; and
individually processing, by the scheduling-optimization circuit, each instance of the updated schedule to produce a corresponding locally-optimized schedule instance.

11. The non-transitory computer-readable medium of claim 10, comprising displacing a prior task on the schedule with one or more of the new tasks and performing a dynamic schedule repair for a variable planning horizon.

12. The non-transitory computer-readable medium of claim 9, wherein the shared resource comprises one or more antennas for communicating with one or more satellites.

13. The non-transitory computer-readable medium of claim 9, wherein the scheduling optimization circuit comprises a particle swarm generation circuit.

14. The non-transitory computer-readable medium of claim 13, wherein the particle swarm generation circuit comprises local rules, and wherein the particle swarm generation circuit varies the local rules for each schedule instance based on either a deterministic function or a stochastic function, and further based on the global rule set.

15. The non-transitory computer-readable medium of claim 9, wherein the global rule set comprises an identification of limited resources, priority constraints, and task timing constraints.

16. The non-transitory computer-readable medium of claim 9, wherein the processing by the scheduling-optimization circuit optimizes various instances of the locally-optimized schedule instance based on different circumstances.

17. A system comprising:
a computer processor; and
a memory coupled to the computer processor;
wherein the computer processor is operable for:
generating multiple instances of a schedule for operation of multiple sets of shared resources;
individually processing, by a scheduling-optimization circuit, each instance of the schedule to produce a corresponding locally-optimized schedule instance;
applying a set of evaluation criteria and a set of selection logic to each locally-optimized schedule instance to select a best schedule to meet a current circumstance represented by a global rule set;
receiving an updated global rule set representing a change to the current circumstance;
adjusting the set of evaluation criteria and the set of selection logic in response to the updated global rule set to produce an updated set of evaluation criteria and an updated set of selection logic;
updating dynamic priorities to optimize each locally optimized schedule instance and updating local rule sets based on tasking patterns learned from machine learning techniques; and
applying the updated set of evaluation criteria and the updated set of selection logic to each locally-optimized schedule instance to select the best schedule to meet the current circumstance represented by the updated global rule set.

18. The system of claim 17, wherein the computer processor is operable for:
receiving a set of new requests for addition of new tasks to the schedule; and
in response to the set of new requests:
generating multiple instances of an updated schedule for operation of the multiple sets of the shared resources taking into account the set of new requests; and
individually processing, by the scheduling-optimization circuit, each instance of the updated schedule to produce a corresponding locally-optimized schedule instance.

19. The system of claim 17, wherein the shared resource comprises one or more antennas for communicating with one or more satellites.

20. The system of claim 17, wherein the scheduling optimization circuit comprises a particle swarm generation circuit.
